(19) United States
(12) Patent Application Publication
(10) Pub. No.: US 2025/0342594 A1
(43) Pub. Date: Nov. 6, 2025

(54) SYSTEM AND METHOD FOR TUMOR PROGRESSION QUANTIFICATION WITH UNSUPERVISED IMAGE REGISTRATION AND SPARSELY SUPERVISED UNIVERSAL LESION SEGMENTATION

(71) Applicant: eResearch Technology, Inc., Philadelphia, PA (US)

(72) Inventors: Alessandro Delmonte, Philadelphia, PA (US); Joël Schaerer, Philadelphia, PA (US); Dharmendra Modi, Philadelphia, PA (US); Brian Wehrle, Philadelphia, PA (US); Erin Bowman, Philadelphia, PA (US)

(73) Assignee: eResearch Technology, Inc., Philadelphia, PA (US)

(21) Appl. No.: 18/901,674

(22) Filed: Sep. 30, 2024

Related U.S. Application Data
(60) Provisional application No. 63/641,019, filed on May 1, 2024.

(51) Int. Cl. G06T 7/00; G06T 7/13

(52) U.S. Cl. CPC G06T 7/0016; G06T 7/13; G06T 2207/10081; G06T 2207/20081; G06T 2207/20084; G06T 2207/30096

(57) ABSTRACT

Exemplary system and methods propagate a lesion to measure tumor progression and response. Plural images of a patient obtained during plural computed tomography scans are received which include a set of baseline images and a set of supplement images obtained at a different time points. Each received image is analyzed to detect an organ and perform organ segmentation on the image in which an organ is detected. A contour for at least one baseline image in the set of baseline images on which organ segmentation is performed is received from a user. The annotated baseline image is aligned onto a supplement image of the set of supplement images. The aligned images are registered based on the lesion of interest, and universal lesion segmentation is performed to predict new lesion contours. Biomarkers are extracted from the registered and aligned images based on new lesion contours associated with the lesion of interest.

### FIELD

The present disclosure is related to methods and systems for method for propagating a lesion to measure tumor progression and response.

### BACKGROUND

Imaging data is commonly used as an endpoint in oncology clinical trials. The most important endpoints are based on the concept of tumor progression, which is defined using medical imaging. For solid tumors, the RECIST1.1 criteria is the most used protocol to assess patient progression over time. This protocol requires the annotation of the lesion of interest at different time-points to model tumor biomarkers over time. Artificial intelligence in computer vision is becoming the de-facto standard for processing medical images. In the field of oncology, research is focused on automatic tumor delineation (also called tumor segmentation) and detection. Recently, there has been exploration into broader applications, such as universal lesion segmentation.

Tumor progression and response are quantified according to RECIST 1.1 criteria by repetitively annotating lesions and segmenting serial cross-sectional imaging datasets. To reduce annotation burden at scale, automatic longitudinal propagation of baseline lesions is highly desirable. Longitudinal propagation is defined as the identification and segmentation on subsequent or supplement (e.g., follow-up) imaging of specified oncology lesions selected by radiologists at baseline.

Currently, automatic longitudinal propagation is addressed by combining some of the previously described techniques in a unique pipeline. Known image registration techniques can be used as a standalone tool to estimate the parameters of transformations from paired computed tomography (CT) images. Once the parameters allowing the mapping of a baseline image on a follow-up image have been found, the estimated transformation can be applied to warp the lesion segmentation mask corresponding to the baseline selection on the follow-up image space. The warped segmentation is then assumed to represent the lesion at follow-up.

Image registration techniques can be used as a standalone tool to estimate the parameters of transformations from paired CT images. Once the parameters which allow mapping of the baseline image on a follow-up image have been found, the estimated transformation can be applied to warp the lesion segmentation mask corresponding to the baseline selection on the follow-up image space. The warped segmentation is then assumed to represent the lesion at follow-up.

Alternatively, registration can be used in conjunction with image segmentation algorithms. In this scenario, the two time-points are independently segmented to extract all tumor lesions the algorithm can find. Registration is used in conjunction with a matching algorithm, such as the Kuhn-Munkres method, to create one-to-one correspondences between automatically segmented lesions. Once a user contours a lesion on the baseline scan, the matching algorithm check if, for a specified lesion on baseline, a corresponding lesion was available on follow-up. If that is the case, the automatic follow-up segmentation is assumed to represent the propagation of the baseline selection. This approach produces more accurate contours than using registration alone since an automatic segmentation algorithm is specifically designed to predict lesion contours while an image registration algorithm is mostly designed to produce a more general image-to-image matching. However, the drawback is that the segmentation algorithm must correctly identify the lesions of interest at both time-points. If it fails to do so, the matching will not be possible.

Another current option for longitudinal propagation is to use tracking algorithms. Rather than creating dense transformations between images, the tracking algorithm is trained to identify the location of a baseline annotation in the follow-up image, without creating dense transformations for the entire volume. The tracking algorithm can estimate the location of the follow-up image corresponding to the baseline annotation. It can be used in conjunction with automatic segmentation to annotate the baseline lesion at the follow-up time point. To do so, all follow-up lesions are first identified and segmented. Then, the lesion closest to the estimated location is selected to be the propagated contour. This approach is more lightweight than dense correspondence, but it still requires an automatic segmentation algorithm to propagate the contour and is more sensitive to the data used during the training since out-of-distribution annotation may not be correctly tracked.

Lesion propagation algorithms used for oncology trials should perform under challenging conditions. Images acquired at baseline and follow-up may be quite different, due to the spreading of the disease, acquisition protocol difference and subpar image quality. It is not unusual to have a vastly different field-of-view between two images of the same patient at two different time-points (e.g., baseline is a whole-body CT and follow-up is a thorax CT). Registration algorithms can be extremely sensitive to changes in contrast, FOV and acquisition parameters. Additionally, primary tumor segmentation is not sufficient and all metastatic sites and adenopathy should be propagated. A universal segmentation algorithm is necessary to propagate all lesion sites. This can hardly be achieved using fully supervised learning technologies since an AI algorithm capable of performing fully automatic segmentation of all tumor types and metastatic location would have difficulty converging to solution due to the extreme variance of input data and pathology type.

Multiple known solutions perform tumor segmentation at different time-points and then develop matching strategies to find correspondences between automatically segmented lesions (Kuckertz et al., Rochman et al., Hering et al.). However, these solutions may only work for tumor types where automatic segmentation is achievable, which limits their scope and requires new specific development for each pathology. Furthermore, these approaches cannot be robustly extended to metastasis and adenopathy propagation.

Registration-based systems robust to input data with high variance are currently under development and have shown impressive results for deformable registration (Hoffmann et al.). However, these systems still require an initial affine transformation as a pre-processing step, which relies on gradient-based algorithms. New phase-invariant affine registration tools have only been validated on brain images (Hoffmann et al., 2024). Furthermore, registration-based approaches do not enable an exact match of the lesion contour to the follow-up scan in cases where the tumor shape has changed significantly. Additionally, these approaches may not be suitable for two-dimensional annotations, such as the one based on RECIST1.1 criteria since the deformed annotation could potentially span multiple image slices.

Tracking-based solutions, such as those proposed by Cai et al. and Tang et al., can be applied more universally. However, they lack the ability to propagate exact contours. Their efficacy on clinical conditions has not been tested, nor has their robustness on different acquisition protocols.

Fully automatic segmentation algorithms may identify and segment all lesions present in a specified image. However, their applicability is often limited to a specific tumor type or pathology. In general, AI algorithms may be trained using full supervision to automatically segment lesion types present in a training dataset. Training datasets cannot encompass all lesion types that may be found in oncology clinical trials and even in the case such dataset exists, the convergence of the algorithm may be hindered by the extremely high variance of the input. In the context of tumor propagation, unexpected results may occur if the user selects a lesion that was not automatically segmented at the follow-up by the algorithm. This situation can happen for a vast variety of reasons, and it is common in the presence of false negative predictions.

While previous works showed the efficacity of prompt-based algorithms for the segmentation of natural images (Sofiiuk et al., Kirillov et al.), bibliography is scarce for their adaption to medical imaging. A more recent work from Ma et al. showed that bonding box prompts can be used to adapt prompt-based algorithms to the universal segmentation of medical images. Unfortunately, bounding boxes cannot be trivially used in the context of lesion propagation since in addition to automatically track tumor location, the registration algorithm should also perfectly track tumor extension.

Prompt-based universal lesion segmentation solutions based on bonding boxes, such as those proposed by Ma et al., may be challenging to adapt to rapidly evolving tumors. Point-based systems, as developed by Ju et al. for organ segmentation and Sofiiuk et al. for natural image processing, have not been integrated in pipelines aiming to assess tumor response in the context of longitudinal evaluation of oncology patients.

There is a need for a tool that can understand the user selection and that has a consistent behavior for different tumor types. To achieve this, the AI algorithm must learn to contour a lesion independently from the lesion type, lesion location, and imaging modality. Consequently, the system must perform universal lesion segmentation at the location corresponding to the selected lesion in the follow-up image. This type of interactive systems that can adapt their output to the user input are called prompt-based algorithms. A system performing automatic tumor propagation should be robust to changes in acquisition protocol, primary tumor type, and metastasis location. Currently, there is no solution validated on real scenarios that addresses all situations and conditions. There are a limited number of proof-of-concept solutions exist that provide solutions for narrower scopes. Tumor propagation is thus currently performed manually by trained radiologists in a very time-consuming and expensive operation.

### SUMMARY

An exemplary system for propagating a lesion to measure tumor progression and response is disclosed, the system comprising: memory for storing program code for generating one or more neural networks trained for performing an affine registration system and a modality-modality agnostic deformable registration system; a computing system having a processor which executes the program code stored in memory, the processor executing the program causes the computer system to be configured to: receive, by a receiving device of the computing system, plural images of a patient obtained during plural computed tomography scans, the plural images including a set of baseline images and a set of supplement images obtained at a different time points; analyze, by the processor of the computing system, each received image to detect an organ and perform organ segmentation on the image in which an organ is detected; receive, by an input device of the computing system, a contour input for at least one baseline image in the set of baseline images on which organ segmentation is performed, the contour input annotating the at least one baseline image to delineate a lesion of interest on an organ; identify, by the processor, correspondence between one or more anatomical locations in the at least one annotated baseline image and a supplement image in the set of supplement images to establish an image pair; align, by the processor, the at least one annotated baseline image and the supplement image of the image pair; register, by the processor configured to execute a phase-agnostic algorithm, the aligned images of the image pair to identify coordinates of the lesion of interest; perform, by the processor, universal lesion segmentation on the registered image pair based on attributes of the supplemental image to predict new lesion contours for the lesion of interest; extract, by the processor, biomarkers from the registered image pair based on the new lesion contours associated with the lesion of interest; and generate, by the processor, an output signal including the biomarkers.

An exemplary method for propagating a lesion to measure tumor progression and response is disclosed, the method comprising: receiving, by a receiving device of a computing system, plural images of a patient obtained during plural computed tomography scans, the plural images including a set of baseline images and a set of supplement images obtained at a different time points; analyzing, by a processor of the computing system, each received image to detect an organ and perform organ segmentation on the image in which an organ is detected; receiving, by an input device of the computing system, a contour input for at least one baseline image in the set of baseline images on which organ segmentation is performed, the contour input annotating the at least one baseline image to delineate a lesion of interest on an organ; identifying, by the processor, correspondence between one or more anatomical locations in the at least one annotated baseline image and a supplement image in the set of supplement images to establish an image pair; aligning, by the processor, the at least one baseline image and the supplement image of the image pair to generate aligned images; registering, by the processor, the aligned images of the image pair to identify coordinates of the lesion of interest; performing, by the processor, universal lesion segmentation on the registered image pair based on attributes of the supplemental image to predict new lesion contours for the lesion of interest; extracting, by the processor, biomarkers from the registered image pair based on the new lesion contours associated with the lesion of interest; and generating, by the processor, an output signal including the biomarkers.

A non-transitory computer readable medium storing program code for propagating a lesion to measure tumor progression and response is disclosed. The non-transitory computer readable medium when placed in communicable contact with a computing system the computer readable medium causing the computing system to perform operations comprising: receiving, by a receiving device of a computing system, plural images of a patient obtained during plural computed tomography scans, the plural images including a set of baseline images and a set of supplement images obtained at a different time points; analyzing, by at least one processor of the computing system, each received image to detect an organ and perform organ segmentation on the image in which an organ is detected; receiving, by an input device of the computing system, a contour input for at least one baseline image in the set of baseline images on which organ segmentation is performed, the contour input annotating the at least one baseline image to delineate a lesion of interest on an organ; identifying, by the at least one processor, correspondence between one or more anatomical locations in the at least one annotated baseline image and a supplement image in the set of supplement images to establish an image pair; aligning, by the at least one processor, the annotated baseline image and the supplement image of the of the image pair; registering, by the at least one processor executing a phase-agnostic algorithm, the aligned images of the image pair to identify coordinates of the lesion of interest; performing, by the processor, universal lesion segmentation on the registered images of the image pair to predict new lesion contours for the lesion of interest; extracting, by the at least one processor, biomarkers from the registered and aligned images of the image pair based on the new lesion contours associated with the lesion of interest; and generating, by the processor, an output signal including the biomarkers.

### DESCRIPTION OF THE DRAWING FIGURES

Exemplary embodiments are best understood from the following detailed description when read in conjunction with the accompanying drawings. Included in the drawings are the following figures:

FIG. 1 illustrates a system overview for propagating a lesion to measure tumor progression and response in accordance with an exemplary embodiment of the present disclosure.

FIG. 2 illustrates a process overview for propagating a lesion to measure tumor progression and response in accordance with an exemplary embodiment of the present disclosure.

FIGS. 3A to 3D illustrate CT scan data in accordance with an exemplary embodiment of the present disclosure.

FIGS. 4A to 4D illustrate an output of the system 100 in accordance with an exemplary embodiment of the present disclosure.

FIG. 5 illustrates an image processing data flow in accordance with an exemplary embodiment of the present disclosure.

FIGS. 6A and 6B illustrate a deep learning neural network in accordance with an exemplary embodiment of the present disclosure.

FIGS. 7A and 7B are graphs illustrating an overall registration performance and by-anatomy performance of the system 100 in accordance with an exemplary embodiment.

FIGS. 8A to 8C are graphs illustrating universal lesion segmentation performance of the system 100 in accordance with an exemplary embodiment of the present disclosure.

FIG. 9 is a graph illustrating a Bland-Altman plot in accordance with an exemplary embodiment of the present disclosure.

FIG. 10 illustrates a method for propagating a lesion to measure tumor progression and response in accordance with an exemplary embodiment of the present disclosure.

FIG. 11 illustrates a hardware configuration of the computing device in accordance with an exemplary embodiment of the present disclosure.

Further areas of applicability of the present disclosure will become apparent from the detailed description provided hereinafter. It should be understood that the detailed descriptions of exemplary embodiments are intended for illustration purposes only and, therefore, are not intended to necessarily limit the scope of the disclosure.

### DETAILED DESCRIPTION

In accordance with exemplary embodiments of the present disclosure, systems, and methods for propagating a lesion to measure tumor progression and response combine a novel image registration pipeline with universal prompt-based lesion segmentation to accurately propagate a lesion delineated by a radiologist at baseline using RECIST1.1 criteria to subsequent time points.

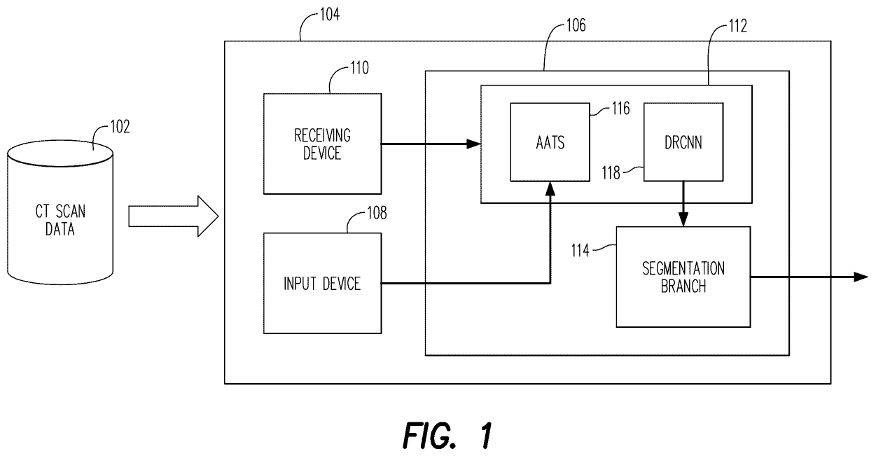

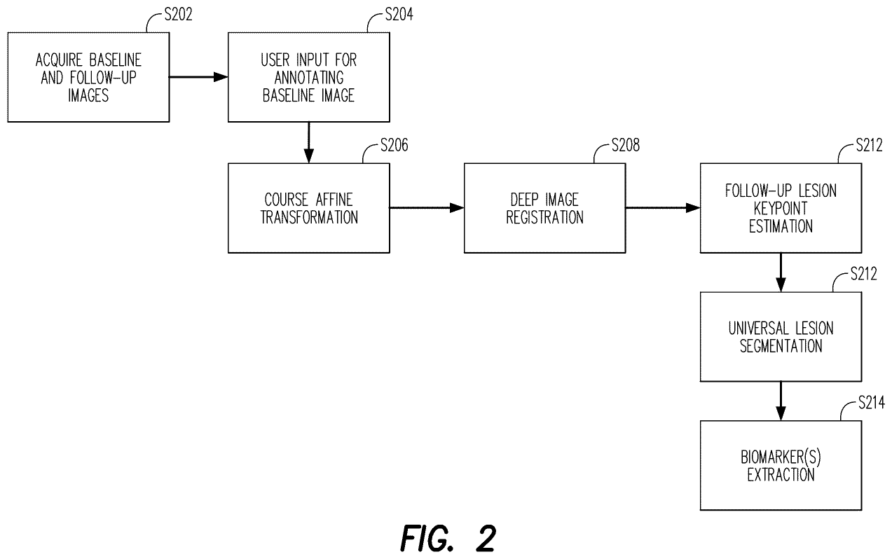

FIG. 1 illustrates a system overview for propagating a lesion to measure tumor progression and response in accordance with an exemplary embodiment of the present disclosure. FIG. 2 illustrates a process overview for propagating a lesion to measure tumor progression and response in accordance with an exemplary embodiment of the present disclosure. As shown in FIG. 1, the system 100 includes memory 102 for storing program code for generating one or more neural networks trained for performing an affine registration system and a modality-modality agnostic deformable registration system. The system 100 also includes a computing system 104 having at least one processor 106 which executes the program code stored in memory 102, an input device 108 for receiving input from a user, and a receiving device 110 configured to receive plural images of a patient obtained during plural computed tomography (CT) scans. The memory 102 can store the CT scan data, which includes a set of baseline images and a set of supplement images obtained at a different time points. The plural images can include a set of baseline images and a set of supplement (follow-up) images obtained at a different time points.

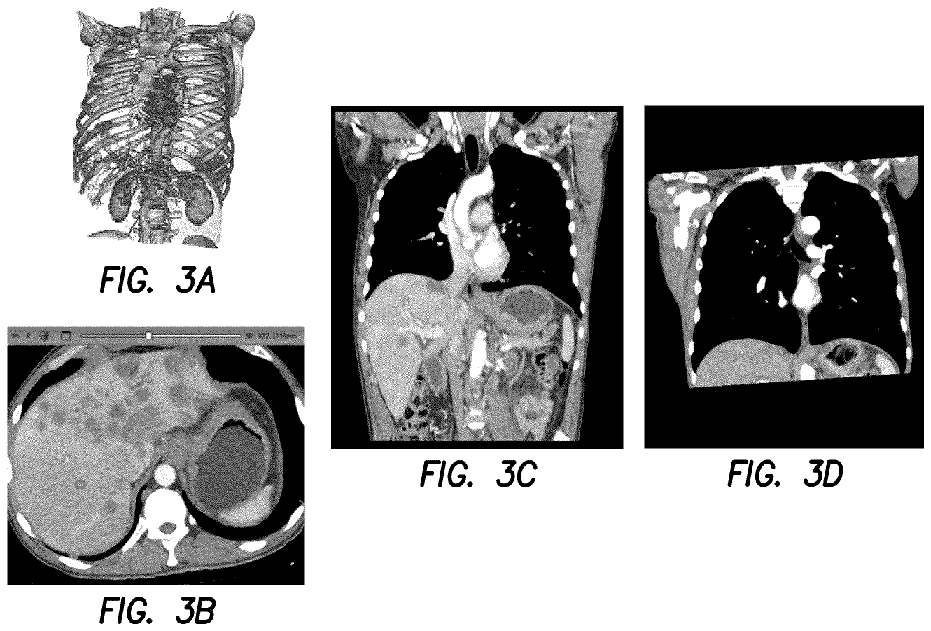

FIGS. 3A to 3D illustrate CT scan data in accordance with an exemplary embodiment of the present disclosure. As shown in FIGS. 3A, 3C, and 3D, the baseline image 302 and the supplement images 304, 306 can be acquired from the same location in a patient's body relevant to a target mass, such as the location of a lesion, organ, or tumor point of reference of reference. At S202 of FIG. 2, the images can be acquired at multiple time points so that a progression or change in the target mass over time can be documented.

The input device 108 can include a user interface configured for interacting with a user. For example, the input device can include a combination of hardware and software components that allow a user to view the CT scan data and annotate baseline images among other operations. FIG. 3B illustrates an annotated baseline image in accordance with an exemplary embodiment. As shown in FIG. 2 (S204), the computing system 104 receives, by the input device 108, a contour input 208 for at least one baseline image 202 in the set of baseline images on which organ segmentation is performed. As shown in FIG. 3B, the contour input 308 provides an annotation on the at least one baseline image 302 to delineate at least a portion of a target mass, such as a lesion of interest on an organ.

The processor 106 executes the program code, which causes the computer system 100 to be configured to include a registration branch 112 and segmentation branch 114. The registration branch 112 includes an anatomy-aware affine transformation system (AATS) 116 and a modality-agnostic deformable registration convolutional neural network (DRCNN) 118. Through the AATS 116, the processor 106 performs a coarse initialization between two images (S206). For example, the processor 106 analyzes each received image to detect an organ and perform organ segmentation on the image in which an organ is detected. The analysis can include analyzing the data (e.g., metadata) associated with or embedded in each received image to obtain a field of view measurement. The processor 106 identifies correspondence between one or more anatomical locations in the at least one annotated baseline image 308 and a supplement image 304, 306 in the set of supplement images to establish an image pair. The processor 106 aligns the annotated baseline image 308 onto a supplement image 304, 306 of the set of supplement image to generate aligned images. As shown in FIG. 2, the alignment process can be performed through a coarse alignment using an affine transformation algorithm or gradient based tools (S206). An affine transformation is a geometric transformation that preserves lines parallelism, it is usually fast to compute and can provide a suitable degree of overlap between two images. During the alignment operation, the processor 106 performs whole-body segmentation on the received images and compares the field of view measurement for at least one baseline image 302 and at least one supplement image 304, 306 based on results of the whole-body segmentation. The processor 106 identifies one or more common anatomical locations in the at least one annotated baseline image 308 and the supplement image 304, 306 at the different time points following whole-body organ segmentation. The one or more common anatomical locations in each of the at least one annotated baseline image and the supplement image are cropped to obtain a minimal region of interest based on the common anatomical locations. According to exemplary embodiments of the present disclosure, the minimal region of interest is the smallest region completely containing all common anatomical location between the two images. For example, an image 1 can contain vertebrae T1 to T8 and an image 2 can contain vertebrae T3 to T10. The smallest region of interest between the two images would be T3 to T8. The supplement image for each image pair being selected based on the whole-body segmentation results that match the annotated baseline image.

The processor 106 registers the aligned images of the image pairs generated by the AATS 116 to identify coordinates of the lesion of interest (S208). According to an exemplary embodiment the aligned images of each image pair output by the AATS 116 are passed to the DRCNN 118 to establish an exact correspondence between two aligned images at the voxel level. The processor 106 identifies a voxel in the supplement image that corresponds one or more voxels in the at least one annotated baseline image. The voxel is identified in the supplement image by estimating a deformation field between the aligned images and applying a deformation field to determine the voxel coordinate in the supplement image (S210). Based on the voxel coordinate identified in the supplement image, the processor 106 identifies a barycenter of the lesion of interest in the annotated baseline image. Next, a correspondence between a voxel coordinate in the supplement image and the barycenter of the lesion in the at least one annotated baseline image is determined. As a result, of the operations performed in the registration branch 112, the processor 106 establishes a one-to-one correspondence between the one or more anatomical locations in the at least one annotated baseline image and the supplement image. For example, the computing system 104 uses the AATS 116 and the DRCNN 118 to improve the overall registration performance under challenging conditions such as changes in acquisition protocols between multiple and/or different time-points by outputting a voxel coordinate of a supplement image that corresponds to the barycenter of the lesion drawn at baseline.

The segmentation branch 114 is configured to perform whole-body organ segmentation and identify an anatomical region of interest. For example, the processor 106 performs universal lesion segmentation on the registered image pair output from the registration branch 112 based on attributes of the supplemental image. Prior to performing universal lesion segmentation, the processor 106 analyzes the registered image pair to identify a barycenter of the lesion of interest in the supplement image. Universal segmentation is then performed on the supplement image based on the identified barycenter of the lesion of interest to predict the new lesion contours in the supplement image (S212). The biomarkers of the new lesion contours in the supplement image are extracted (S214) and transmitted to the user interface.

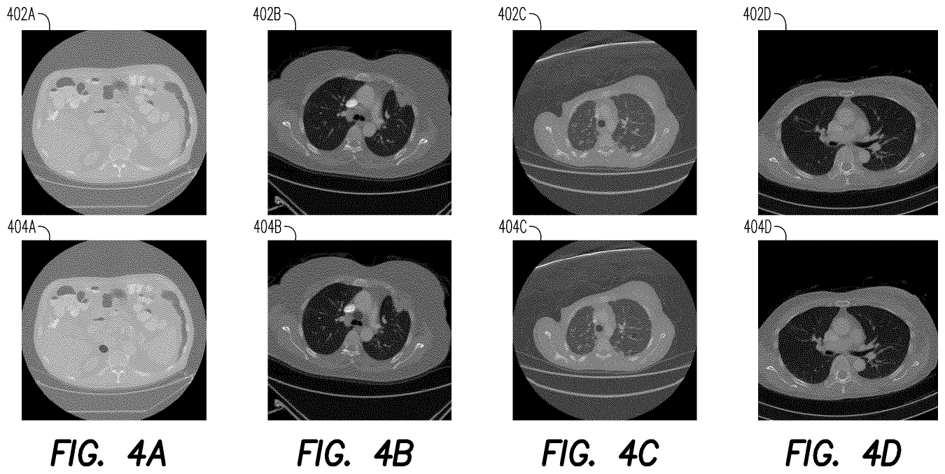

FIGS. 4A to 4D illustrate an output of the system 100 in accordance with an exemplary embodiment of the present disclosure. Each of FIGS. 4A to 4D include a raw or original CT image 402A, 402B, 402C, 402D of a patient and an image 404A, 404B, 404C, 404D resulting from the automated annotation of a supplement image containing a lesion overlaid on the original image.

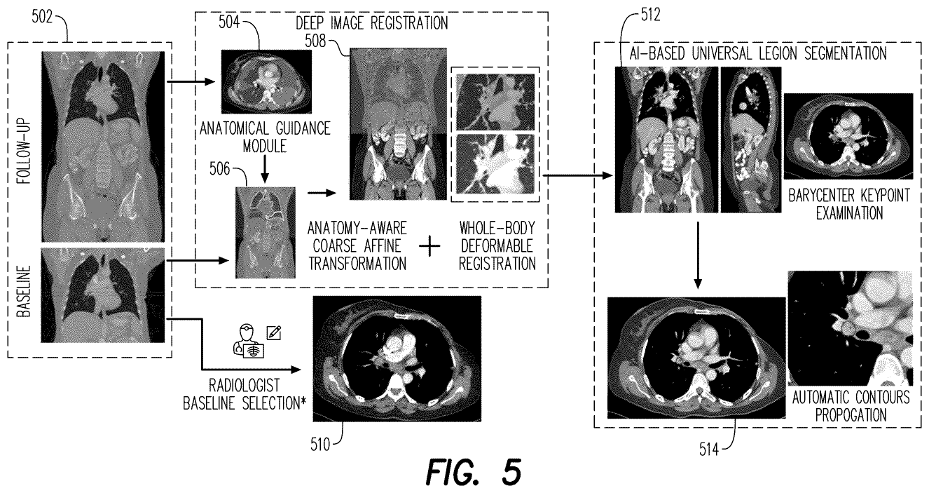

FIG. 5 illustrates an image processing data flow in accordance with an exemplary embodiment of the present disclosure. As shown in FIG. 5, from paired CT datasets 502, the system 100 passes the images through a registration branch 112 for precise image registration by integrating an anatomical guidance module 504 into an artificial neural network that predicts affine transformation parameters and provides a coarse initial registration 506. Deep image registration is completed by a convolutional neural network for fine-grained deformable registration 508. Based on a user-annotated baseline lesion 510, the system estimates the barycenter coordinates for sequential time points 512. The estimated barycenter coordinates are passed to the segmentation branch 114 which performs a universal lesion segmentation algorithm for automatic contour segmentation of the images 514.

The registration branch 112 and segmentation branch 114 operations performed by the processor 106 enhance and improve the robustness of image processing when the two time points of the baseline image and the supplement image, respectively, have disparate fields-of-view (FOV). According to exemplary embodiments of the present disclosure, the image acquisition and universal segmentation of images performed by the processor 106 can be based on whole-body CT scans, which can be advantageous when searching for metastasis in a patient. Further, because for images acquired in subsequent time points, the FOV is focused on the disease area, the exemplary systems and methods described herein can be used to reduce the dose of ionizing radiation to the patient. The segmentation branch 114 can estimate the affine transformation parameters between the two images after region-of-interest cropping. The processor 106 performs universal lesion segmentation on the registered images to predict new lesion contours for the lesion of interest, and extracts biomarkers from the registered and aligned images based on the new lesion contours associated with the lesion of interest. The transformer-based architecture can be trained on paired acquisitions with semi-supervision using a two-term loss function, having one term maximizing image similarity and the second maximizing the overlap between the organs present in both acquisitions. Further, the segmentation branch 114 can estimate the deformation field between the affine-transformed baseline image and the fixed supplement image of CT images of the whole body, abdomen, and thorax.

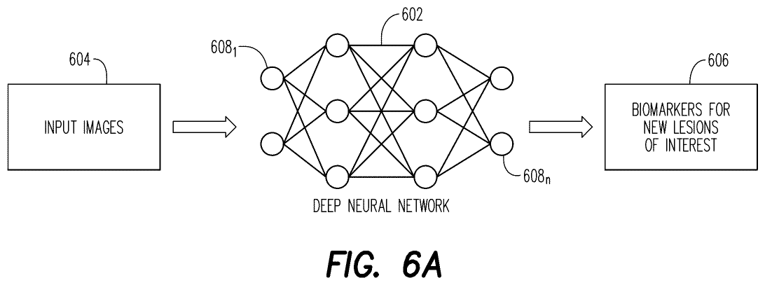

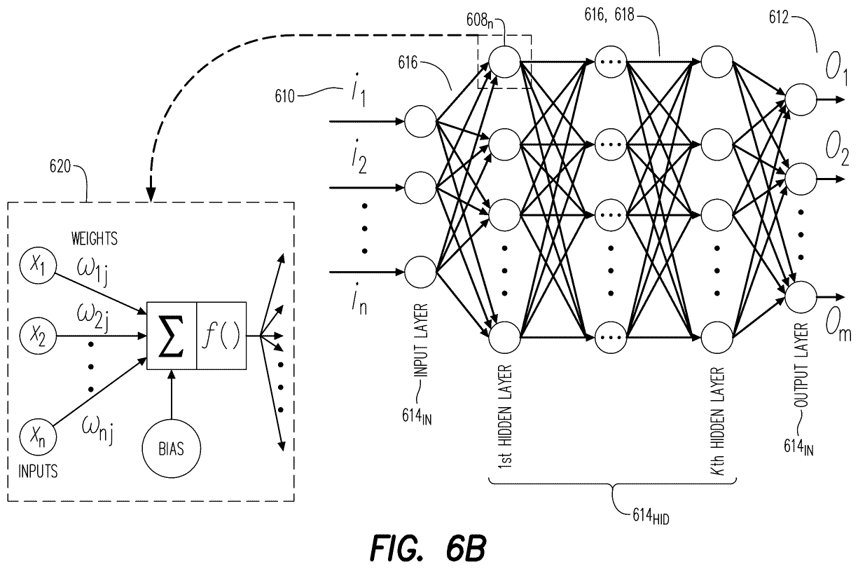

The system 100 can include one or more artificial intelligence (AI) or machine learning models (ML) 114. FIGS. 6A and 6B illustrate a deep learning neural network in accordance with an exemplary embodiment of the present disclosure. The algorithms for coarse affine transformation (S124), deep image registration (S126), follow-up lesion keypoint estimation (S128), and universal lesion segmentation (S130) can be implemented and/or realized through one or more deep learning (DL) network architectures 602, such as convolutional neural networks (CNNs) so that from acquired CT scan images of a patient 604 the network 602 can generate a biomarker for a new lesion of interest 606. Neural networks can include plural nodes that represent individual computational units. Each node has one or more biased input/output connections that function as transfer or activation functions for combining the inputs and outputs in a specified manner. As shown in FIG. 6A the neural network 600 includes plural nodes 608₁ to 608ₙ where each node 608ₙ has one or more inputs (i) 610 and outputs (0) 612 for processing the baseline and supplement images (i.e., input images 604). The neural network 602 is formed by an arrangement of the plural nodes 608ₙ into multiple layers 614, the scheme within which the nodes 608ₙ are connected determines the type and operation of the neural network 600. For example, as shown in FIG. 6B, the neural network 600 can include an input layer 614_{IN}, multiple hidden layers 614_{HDD}, and an output layer 614OUT. Each layer 614 may perform a different or specified transformation on the respective inputs, using a different or specified mathematical calculation or function. Signals travel or are passed between the layers 614, from the input layer 614_{IL} to the output layer 614OUT via the middle or hidden layers 614_{HID} and can traverse any layer 614 and node(s) 608 multiple times. As shown in FIG. 6B, the nodes 608ₙ can be connected in an array and each node can transmit a signal to a node in another layer 614 of the neural network 600. The input/output connections 616,618 between the nodes have a corresponding weight Wₙⱼ and are combined according to the bias applied at each node. For example, the connections 616,618 are activation or transfer functions which trigger the respective nodes and combine inputs according to mathematical equations or formulas 620 according to the bias. According to these neural network principles, and as shown in FIG. 6B, the images are received at an input layer 614_{IN} of the neural network 600 and passed through multiple hidden layers 614_{HDD} until biomarkers for new lesion contours associated with a lesion of interest are identified.

According to exemplary embodiments of the present disclosure, the segmentation branch 114 includes at least one neural network trained for prompt-based universal segmentation using the lesion barycenter given by the registration branch 112 to simulate a user interaction. Furthermore, the neural network segmentation capability of the segmentation branch 114 can be trained from various datasets, which can include RECIST1.1 annotations representing multiple anatomies, pathologies, and acquisition protocols. The training process can be adapted to process one-prompt interactions during training. Finally, RECIST1.1 biomarkers such as short and long diameters can be automatically estimated from the supplement contours.

According to an exemplary embodiment, the AATS 116 can be trained without supervision on 1,098 retrospective multiphasic paired CT datasets. When the trained AATS 116 is combined with a DRCNN 118 for deformable registration, the registration branch 112 infers lesion location correspondences between timepoints that is robust regarding acquisition conditions. 2) The segmentation branch 114 can be trained from very sparse RECIST labels, accounting for 4,238 target lesions annotated by expert radiologists. Coarse lesion location and sparse RECIST masks can be included in the training to establish a promptable segmentation model capable of embedding a radiologists' baseline selection. During training, lesion coordinates simulating manual selection produce strong anatomical priors, accounting for negative supervision deriving from missing annotations and enabling the model to effectively focus on target lesions.

### Use Case

In an exemplary use case, the system is evaluated on 667 datasets corresponding to 22 lesion sites and 5 primary tumor types, acquired using heterogeneous protocols. Registration was evaluated using the mean Euclidean distance (mED), with a 50% limit on lesion area variation to limit bias due to tumor morphological changes. Dice Similarity Coefficient (DSC) and Pearson correlation were evaluated for lesion segmentation. When evaluated, the registration error with respect to the lesion barycenter at the supplement image was 5.39 mm (median: 3.86 mm). No statistically significant differences were found in short axis (p=0.26). Strong correlation was confirmed for off-center prompts, up to the 90th percentile of registration error (ED_90=10.09 mm, DSC-68.90%, r=0.86).

From the results, the system 100 enables more precise lesion location and propagation between time-points as compared to known systems and techniques. The ULS performed by the segmentation branch 114 provided enhanced segmentation performances over known systems and techniques when using automatic prompts issued by image registration. The results show that the system 100 provides consistent predictions using challenging datasets highlighting both tumor-agnostic and sequence-agnostic properties, which supports the system 100 being used in different clinical indications.

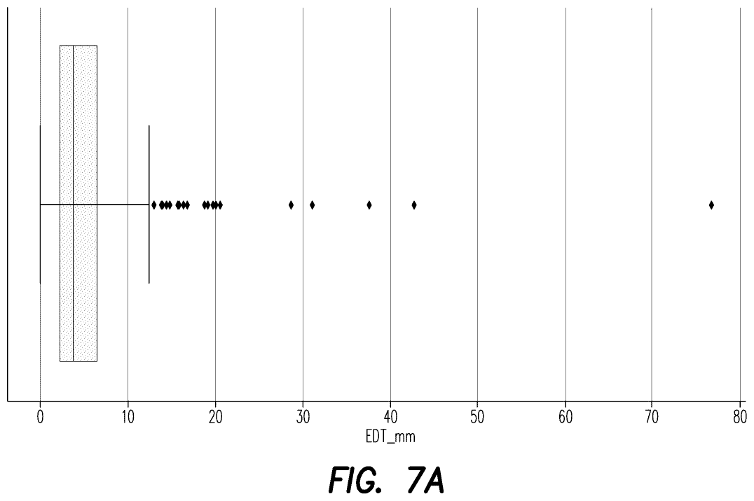

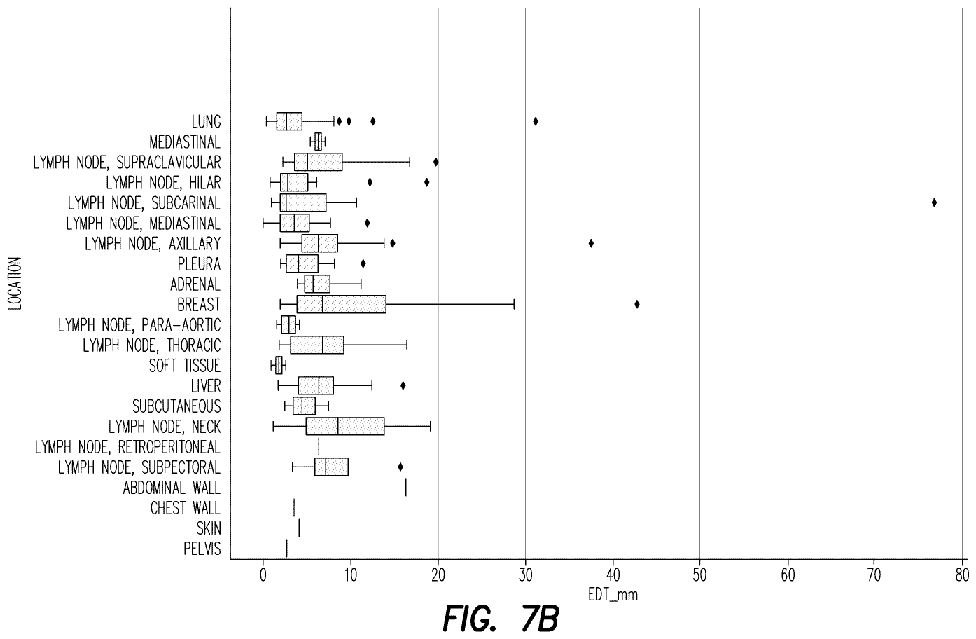

FIGS. 7A and 7B are graphs illustrating an overall registration performance and by-anatomy (bottom row) performance of the system 100 in accordance with an exemplary embodiment. FIG. 7A demonstrates the efficacy of the algorithm in identifying the precise lesion barycenter at follow-up, utilizing a baseline image and a user-provided annotation. FIG. 7B provides a detailed overview of the segmentation performance of the algorithm for each of the 22 anatomies corresponding to the lesions included in the validation dataset. The accuracy is determined by calculating the difference between the predicted follow-up lesion barycenter and the ground-truth, manually annotated, lesion barycenter. The distance is expressed in millimeters, with a lower value indicating a better result. Prompted at lesion center, the ULS performed by the segmentation branch 114 showed high overlap (DSC=75.77%) and very strong correlation for all RECIST measures (SD r=0.91, LD r=0.88, Sum of axis r=0.91).

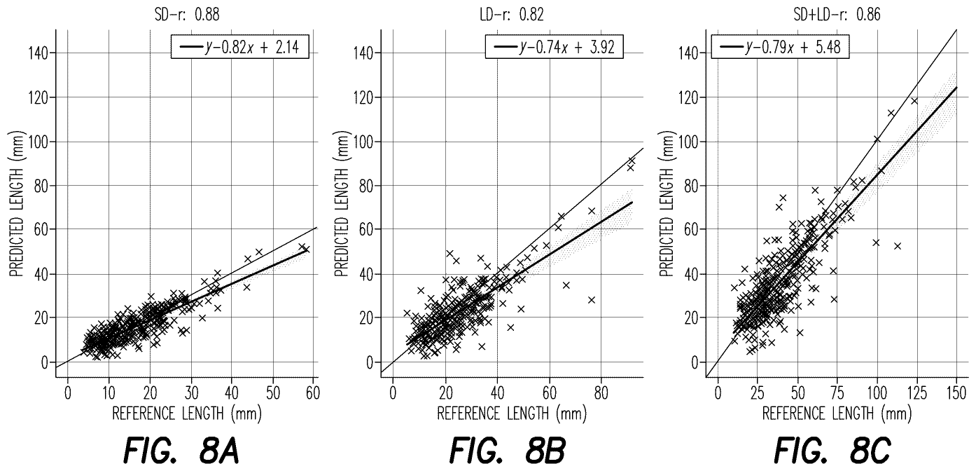

FIGS. 8A to 8C are graphs illustrating universal lesion segmentation performance of the system 100 in accordance with an exemplary embodiment of the present disclosure. FIGS. 8A to 8C illustrate the correlation between the RECIST1.1 biomarkers automatically extracted by the algorithm and the RECIST1.1 biomarkers extracted from ground-truth manual annotations. The biomarkers are calculated using the automatically propagated lesion contours at the follow-up time point for each individual lesion. FIG. 8A illustrates the correlation between the algorithm results and a manual annotation in lesion short axis (SD. The short axis diameter is measured perpendicular to the longest diameter of the lesion. The predicted SD values in millimeters are plotted on the y-axis with respect to the manual annotations reference on the x-axis. Each predicted value is indicated with a black cross. The linear regression line is indicated with a bold line, having an intercept of 2.14 and a slope of 0.82, as indicated in the top-left formula. The Pearson's coefficient between the predicted and reference SD is 0.88, as indicated in the figure title. FIG. 8B illustrates the correlation between the algorithm results and a manual annotation in lesion long axis (LD). The long axis diameter is measured perpendicular to the shortest diameter of the lesion. The predicted LD values in millimeters are plotted on the y-axis with respect to the manual annotations reference on the x-axis. Each predicted value is indicated with a black cross. The linear regression line is indicated with a bold line, having an intercept of 3.92 and a slope of 0.74, as indicated in the top-left formula. The Pearson's coefficient between the predicted and reference LD is 0.82, as indicated in the figure title. FIG. 8C illustrates the correlation between the algorithm results and a manual annotation in lesion sum of axis (SD+LD). The lesion sum of axis is equivalent to the sum of the lesion short axis and the lesion long axis, The predicted SD+LD values in millimeters are plotted on the y-axis with respect to the manual annotations reference on the x-axis. Each predicted value is indicated with a black cross. The linear regression line is indicated with a bold line, having an intercept of 5.48 and a slope of 0.79, as indicated in the top-left formula. The Pearson's coefficient between the predicted and reference SD+LD is 0.86, as indicated in the figure title. FIGS. 8A to 8C confirms a very high correlation between biomarkers extracted from manual annotations and biomarkers extracted from the automatic universal lesion propagation system. No statistically significant differences were found in short axis (p=0.26). Strong correlation was confirmed for off-center prompts, up to the 90th percentile of registration error (ED_90=10.09 mm, DSC=68.90%, r=0.86).

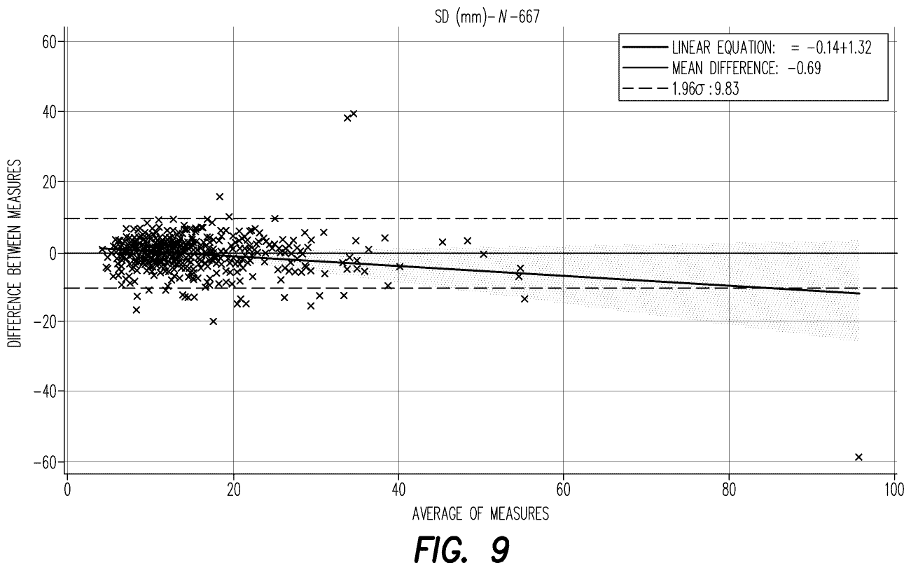

FIG. 9 is a graph illustrating a Bland-Altman plot in accordance with an exemplary embodiment of the present disclosure. The Bland-Altman plot presents a correlation analysis between the average of the lesion short axis computed from the manual annotation and the lesion short axis automatic lesion propagation system (x-axis) and their difference (y-axis). The bold red line represents the linear regression of the data point, with a slope of −0.14 and an intercept of 1.32. The mean difference is −0.69. The green lines show the margin of error equivalent to 1.96 times the standard deviation of the measurements. The Bland-Altman plot is based on N=667 datasets. The mean difference is nearly zero, the linear regression slope is low, and most data points fall within the margin of error. These factors collectively indicate a high degree of concordance between the manually annotated short axis and the automatically propagated short axis, as confirmed by the Bland-Altman analysis.

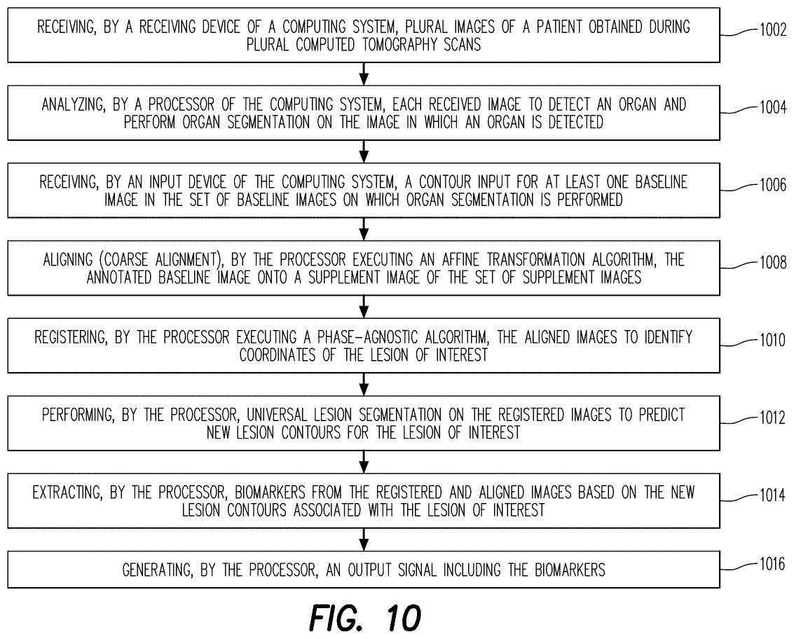

FIG. 10 illustrates a method for propagating a lesion to measure tumor progression and response in accordance with an exemplary embodiment of the present disclosure. As shown in FIG. 2, The receiving device 110 receives plural images of a patient obtained during plural computed tomography scans (S1002). The plural images can include a set of baseline images and a set of supplement (i.e., follow-up) images obtained at a different time points. In step S1004, the processor 106 analyzes each received image to detect an organ and perform organ segmentation on the image in which an organ is detected. In step S1006, the input device 108 receives, from a user, a contour input for at least one baseline image in the set of baseline images on which organ segmentation is performed. The input provided by the user is a contour input that annotates the at least one baseline image to delineate a lesion of interest on an organ. Based on the user input, the processor 106 executes an affine transformation algorithm to align the annotated baseline image onto a supplement image of the set of supplement images (S1008). The supplement image being selected based on organ segmentation results that match the annotated baseline image. In step S1010, the processor 106 registers the aligned images to identify coordinates of the lesion of interest, and in step S712 performs universal lesion segmentation on the registered images to predict new lesion contours for the lesion of interest. In step S1014, biomarkers are extracted from the registered and aligned images based on new lesion contours associated with the lesion of interest. The processor 106 generates an output signal for displaying or printing by a peripheral device (S1016), the output signal including the biomarkers or data associated with the biomarkers.

The exemplary system and methods of the present disclosure can be implemented using a number and arrangement of systems, hardware, and/or modules (e.g., software instructions). For example, the system 100 can include a combination of two or more systems, hardware, and/or modules or may be implemented within a single system, hardware, and/or module. A single system, hardware, and/or module may be implemented as multiple, distributed systems, hardware, and/or modules. Additionally, or alternatively, a set of systems, a set of hardware, and/or a set of modules (e.g., one or more systems, one or more hardware devices, one or more modules) may perform one or more functions described as being performed by another set of systems, another set of hardware, or another set of modules.

The system 100 can be implemented in a configuration suitable for propagating a lesion to measure tumor progression and response as disclosed herein. For example, various components of the system may be implemented in one or more computing devices (e.g., one or more servers, client devices, user devices, and/or the like) and the one or more computing devices may be connected via a communications network (e.g., the Internet).

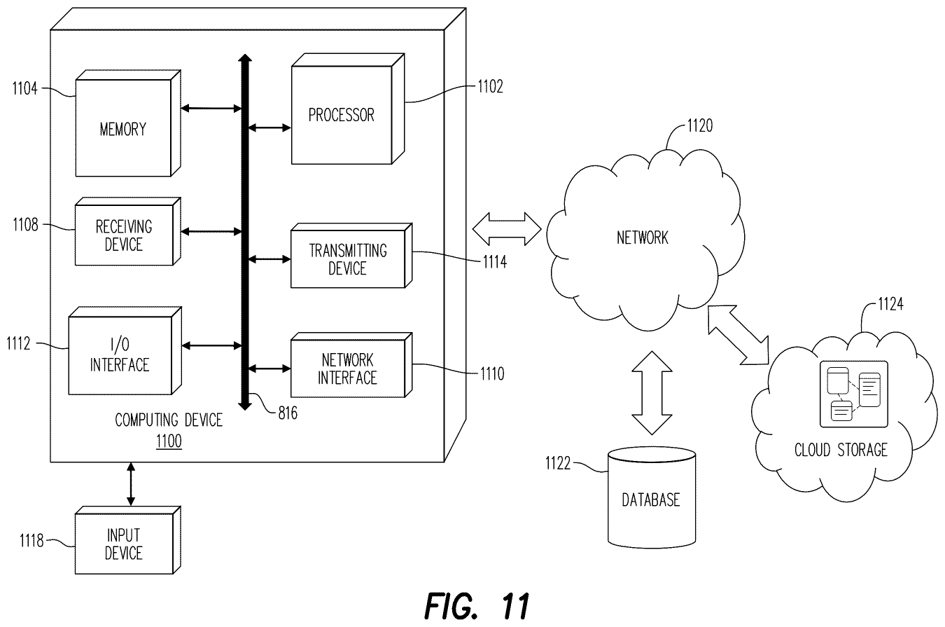

FIG. 11 illustrates an exemplary hardware configuration of a system according to an exemplary embodiment of the present disclosure. As shown in FIG. 11, the system may include a computing system 1100. The computing system 1100 may include a processor (e.g., CPU) 1102 and memory 1104. The processor 1102 may execute software instructions (e.g., program code) for propagating a lesion to measure tumor progression and response. The system 1100 as disclosed herein, can be configured for training machine learning and/or artificial intelligence models (e.g., neural models, neural networks, and/or the like) and for propagating a lesion to measure tumor progression and response with trained machine learning models.

The processor 1102 may be implemented in hardware, software, or a combination of hardware and software. For example, the processor 1102 may include a common processor (e.g., a CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed and/or execute software instructions to perform a function.

Memory 1104 may include random access memory (RAM), read-only memory (ROM), and/or another type of dynamic or static storage device (e.g., flash memory, magnetic memory, optical memory, etc.) that stores information and/or software instructions for use by the processor 1102. Memory 1104 may include a computer-readable medium and/or storage component. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 1104 from another computer-readable medium or from another device via a communication interface with computing device. When executed, software instructions stored in memory may cause the processor to perform one or more processes described herein. Embodiments described herein are not limited to any specific combination of hardware circuitry and software.

Any of the processors disclosed herein can include any integrated circuit or other electronic device (or collection of devices) capable of performing an operation on at least one instruction, which can include a Reduced Instruction Set Core (RISC) processor, a CISC microprocessor, a Microcontroller Unit (MCU), a CISC-based Central Processing Unit (CPU), a Digital Signal Processor (DSP), a Graphics Processing Unit (GPU), a Field Programmable Gate Array (FPGA), etc. The hardware of such devices may be integrated onto a single substrate (e.g., silicon “die”), or distributed among two or more substrates. Various functional aspects of the processor 1102 may be implemented solely as software or firmware associated with the processor 1102.

The processor 1102 can include one or more processing or operating modules. A processing or operating module can be a software or firmware operating module configured to implement any of the functions disclosed herein. The processing or operating module can be embodied as software and stored in memory 1104. The memory 1104 being operatively associated with and communicably coupled to the processor 1102. A processing module can be embodied as a web application, a desktop application, a console application, etc.

The processor 1102 can include or be associated with a computer or machine readable medium. The computer or machine readable medium can include memory. Any of the memory discussed herein can be computer readable memory configured to store data. The memory 1104 can include a volatile or non-volatile, transitory, or non-transitory memory, and be embodied as an in-memory, an active memory, a cloud memory, etc. Examples of memory can include flash memory, Random Access Memory (RAM), Read Only Memory (ROM), Programmable Read only Memory (PROM), Erasable Programmable Read only Memory (EPROM), Electronically Erasable Programmable Read only Memory (EEPROM), FLASH-EPROM, Compact Disc (CD)-ROM, Digital Optical Disc DVD), optical storage, optical medium, a carrier wave, magnetic cassettes, magnetic tape, magnetic disk storage or other magnetic storage devices, or any other medium which can be used to store the desired information and which can accessed by the processor.

The memory 1104 can be a non-transitory computer-readable medium. The term “computer-readable medium” (or “machine-readable medium”) as used herein is an extensible term that refers to any medium or any memory, which participates in providing instructions to the processor for execution, or any mechanism for storing or transmitting information in a form readable by a machine (e.g., a computer). Such a medium may store computer-executable instructions to be executed by a processing element and/or control logic, and data which is manipulated by a processing element and/or control logic, and may take many forms, including but not limited to, non-volatile medium, volatile medium, transmission media, etc. The computer or machine readable medium can be configured to store one or more instructions thereon. The instructions can be in the form of algorithms, program logic, etc. that cause the processor to execute any of the functions disclosed herein.

Embodiments of the memory 1104 can include a processor module and other circuitry to allow for the transfer of data to and from the memory, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc. Communications can be via Bluetooth, near field communications, cellular communications, telemetry communications, Internet communications, etc.

Data stored in the exemplary computing device (e.g., in the memory) can be stored on any type of suitable computer readable media, such as optical storage (e.g., a compact disc, digital versatile disc, Blu-ray disc, etc.), magnetic tape storage (e.g., a hard disk drive), or solid-state drive. An operating system can also be stored in the memory.

In an exemplary embodiment, the data can be configured in any type of suitable database configuration 1122, such as a relational database, a structured query language (SQL) database, a distributed database, an object database, etc. According to an exemplary embodiment, the data can be stored on one or more device configured to operate as cloud storage 1124 on a network 1120. Suitable configurations and storage types will be apparent to persons having skill in the relevant art.

The exemplary computing device 1100 can also include a communications interface 1106. The communications interface 1106 can be configured to allow software and data to be transferred between the computing device and external devices. Exemplary communications interfaces 1106 can include a modem, a network interface (e.g., an Ethernet card), a communications port, a PCMCIA slot and card, etc. Software and data transferred via the communications interface 1106 can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, etc. Transmission of data and signals can be via transmission media. Transmission media can include coaxial cables, copper wire, fiber optics, etc. Transmission media can also take the form of acoustic or light waves, such as those generated during radio-wave and infrared data communications, or other form of propagated signals (e.g., carrier waves, digital signals, etc.).

Memory semiconductors (e.g., DRAMs, etc.) can be means for providing software to the computing device. Computer programs (e.g., computer control logic) can be stored in the memory. Computer programs can also be received via the communications interface. Such computer programs, when executed, can enable computing device to implement the present methods as discussed herein. In particular, the computer programs stored on a non-transitory computer-readable medium, when executed, can enable hardware processor device to implement the methods as discussed herein. Accordingly, such computer programs can represent controllers of the computing device.

According to exemplary embodiments described herein, the combination of the memory 1104 and the processor 1102 can store and/or execute computer program code for performing the specialized functions described herein. The program code can be stored on a non-transitory computer readable medium, such as the memory devices for the computing device, which may be memory semiconductors (e.g., DRAMs, etc.) or other tangible and non-transitory means for providing software to the computing device. For example, via any known or suitable service or platform, the program code can be deployed (e.g., streamed and/or downloaded) remotely from computing devices located on a local-area or wide-area network and/or in a cloud-computing arrangement or environment. In another example, the computer programs (e.g., computer control logic) or software may be stored in memory resident on/in the computing device. The computer programs or software may be stored in a computer program product or non-transitory computer readable medium and loaded into the computing device using any one or combination of a removable storage drive, an interface for internal or external communication, and a hard disk drive, where applicable. The computer programs or software, when executed, may enable the computing device to implement the present methods and exemplary embodiments discussed herein. Accordingly, such computer programs may represent controllers of the computing device.

The computing system 1100 or device may also include a receiver or receiving device 1108, a network interface 1110, an input/output (I/O) interface 1112, a transmitting device 1114, a communication infrastructure 1116, an input device 1118, a communication network 1120, and a database 1122 and/or cloud storage 1124.

The receiver or receiving device 1108 may be a combination of hardware and software components configured to receive data samples from the mobile network or database. According to exemplary embodiments, the receiving device 1108 can include a hardware component such as an antenna, a network interface (e.g., an Ethernet card), a communications port, a Personal Computer Memory Card International Association (PCMCIA) slot and card, 5G New Radio (NR) interface, or any other component or device suitable for use on a mobile communication network or Radio Access Network as desired. The receiving device 1108 can be an input device for receiving signals and/or data samples formatted according to 3GPP protocols and/or standards. The receiving device 1108 can be connected to other devices via a wired or wireless network or via a wired or wireless direct link or peer-to-peer connection without an intermediate device or access point. The hardware and software components of the receiving device 1108 can be configured to receive the data from the mobile network according to one or more communication protocols and data formats. For example, the receiving device 1108 can be configured to communicate over a network 1120, which may include a local area network (LAN), a wide area network (WAN), a wireless network (e.g., Wi-Fi), a mobile communication network, a satellite network, the Internet, fiber optic cable, coaxial cable, infrared, radio frequency (RF), another suitable communication medium as desired, or any combination thereof. During a receive operation, the receiving device 1108 can be configured to identify parts of the received data via a header and parse the data signal and/or data packet into small frames (e.g., bytes, words) or segments for further processing at the processor.

The I/O interface 1112 can be configured to receive the signal from the processor and generate an output suitable for a peripheral device via a direct wired or wireless link. The I/O interface 1112 can include a combination of hardware and software for example, a processor, circuit card, or any other suitable hardware device encoded with program code, software, and/or firmware for communicating with a peripheral device such as a display device, printer, audio output device, or other suitable electronic device or output type as desired.

The transmitting device 1114 can be configured to receive data from the processor and assemble the data into a data signal and/or data packets according to the specified communication protocol and data format of a peripheral device or remote device to which the data is to be sent. The transmitting device 1114 can include any one or more of hardware and software components for generating and communicating the data signal over the communications infrastructure and/or via a direct wired or wireless link to a peripheral or remote device. The transmitting device 1114 can be configured to transmit information according to one or more communication protocols and data formats as discussed in connection with the receiving device.

The input device 1118 is configured to receive an input from a user for processing and/or use by the CPU 1102. For example, the input device 1118 can be implemented as a physical or virtual keyboard, a physical or virtual touchpad, a microphone, or any suitable device for inputting data or information as desired. The input device 1118 can be configured to format the received user input suitable for use by the CPU 1102 or be configured to provide the user input to the I/O interface 1112 for further processing. According to an exemplary embodiment, the input device 1118 can be configured to communicate wirelessly with the computing system 1100 or be integrated into the housing of the computing system 1100 or have a physical connection to the computing device 1100. In performing the described operations, the input device 1118 can be configured to include a combination of hardware and software components.

In the context of exemplary embodiments of the present disclosure, a processor can include one or more modules or engines configured to perform the functions of the exemplary embodiments described herein. Each of the modules or engines may be implemented using hardware and, in some instances, may also utilize software, such as corresponding to program code and/or programs stored in memory. In such instances, program code may be interpreted or compiled by the respective processors (e.g., by a compiling module or engine) prior to execution. For example, the program code may be source code written in a programming language that is translated into a lower level language, such as assembly language or machine code, for execution by the one or more processors and/or any additional hardware components. The process of compiling may include the use of lexical analysis, preprocessing, parsing, semantic analysis, syntax-directed translation, code generation, code optimization, and any other techniques that may be suitable for translation of program code into a lower level language suitable for controlling the system to perform the functions disclosed herein. It will be apparent to persons having skill in the relevant art that such processes result in the system being a specially configured computing device uniquely programmed to perform the functions of the exemplary embodiments described herein.

Various embodiments of the system are further described in the Attachments enclosed herewith.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning and range and equivalence thereof are intended to be embraced therein.

What is claimed is:

1. A method for propagating a lesion to measure tumor progression and response, the method comprising:
receiving, by a receiving device of a computing system, plural images of a patient obtained during plural computed tomography scans, the plural images including a set of baseline images and a set of supplement images obtained at a different time points;
analyzing, by a processor of the computing system, each received image to detect an organ and perform organ segmentation on the image in which an organ is detected;
receiving, by an input device of the computing system, a contour input for at least one baseline image in the set of baseline images on which organ segmentation is performed, the contour input annotating the at least one baseline image to delineate a lesion of interest on an organ;
identifying, by the processor, correspondence between one or more anatomical locations in the at least one annotated baseline image and a supplement image in the set of supplement images to establish an image pair;
aligning, by the processor, the at least one baseline image and the supplement image of the image pair to generate aligned images;
registering, by the processor, the aligned images of the image pair to identify coordinates of the lesion of interest;
performing, by the processor, universal lesion segmentation on the registered image pair based on attributes of the supplemental image to predict new lesion contours for the lesion of interest;
extracting, by the processor, biomarkers from the registered image pair based on the new lesion contours associated with the lesion of interest; and
generating, by the processor, an output signal including the biomarkers.

2. The method of claim 1, wherein analyzing each received image comprises:
analyzing the data of each received image to obtain a field of view measurement.

3. The method of claim 2, further comprising:
performing, by the processor, whole-body segmentation on the received images, and
comparing the field of view measurement for at least one baseline image and at least one supplement image based on results of the whole-body segmentation.

4. The method of claim 3, wherein to establish the image pair based on results of the field of view measurement, the registering step establishes a one-to-one correspondence between the one or more anatomical locations in the at least one annotated baseline image and the supplement image.

5. The method of claim 4, wherein aligning the at least one baseline image and the supplement image comprises:
identifying one or more common anatomical locations in the at least one annotated baseline image and the supplement image at the different time points following whole-body organ segmentation; and
cropping the one or more common anatomical locations in each of the at least one annotated baseline image and the supplement image to obtain a minimal region of interest based on the common anatomical locations.

6. The method of claim 5, wherein registering the aligned images further comprises:
identifying a voxel in the supplement image that corresponds one or more voxels in the at least one annotated baseline image; and
identifying a barycenter of the lesion of interest in the annotated baseline image.

7. The method of claim 6, wherein registering the aligned images further comprises:
determining a voxel coordinate in the supplement image that corresponds to the barycenter of the lesion in the at least one annotated baseline image.

8. The method of claim 7, further comprising:
estimating a deformation field between the aligned images; and
applying a deformation field to determine the voxel coordinate in the supplement image.

9. The method of claim 8, comprising:
identifying a barycenter of the lesion of interest in the supplement image; and
performing universal segmentation on the supplement image based on the identified barycenter of the lesion of interest to predict the new lesion contours in the supplement image.

10. A system for propagating a lesion to measure tumor progression and response, the system comprising:
memory for storing program code for generating one or more neural networks trained for performing an affine registration system and a modality-modality agnostic deformable registration system;
a computing system having a processor which executes the program code stored in memory, the processor executing the program causes the computer system to be configured to:
receive, by a receiving device of the computing system, plural images of a patient obtained during plural computed tomography scans, the plural images including a set of baseline images and a set of supplement images obtained at a different time points;
analyze, by the processor of the computing system, each received image to detect an organ and perform organ segmentation on the image in which an organ is detected;
receive, by an input device of the computing system, a contour input for at least one baseline image in the set of baseline images on which organ segmentation is performed, the contour input annotating the at least one baseline image to delineate a lesion of interest on an organ;
identify, by the processor, correspondence between one or more anatomical locations in the at least one annotated baseline image and a supplement image in the set of supplement images to establish an image pair;
align, by the processor, the at least one annotated baseline image and the supplement image of the image pair;
register, by the processor configured to execute a phase-agnostic algorithm, the aligned images of the image pair to identify coordinates of the lesion of interest;
perform, by the processor, universal lesion segmentation on the registered image pair based on attributes of the supplemental image to predict new lesion contours for the lesion of interest;
extract, by the processor, biomarkers from the registered image pair based on the new lesion contours associated with the lesion of interest; and
generate, by the processor, an output signal including the biomarkers.

11. The system of claim 10, wherein the processor is configured to:
analyze the data of each received image to obtain a field of view measurement.

12. The system of claim 11, wherein the processor is configured to:
perform whole-body segmentation on the received images; and
compare the field of view measurement for at least one baseline image and at least one supplement image based on results of the whole-body segmentation.

13. The system of claim 12, wherein to establish the image pair based on results of the field of view measurement, the processor is configured to:
establish a one-to-one correspondence between the one or more anatomical locations in the at least one annotated baseline image and the supplement image.

14. The system of claim 13, wherein to align the at least one baseline image and the supplement image, the processor is configured to:
identify one or more common anatomical locations in the at least one annotated baseline image and the supplement image at the different time points following whole-body organ segmentation; and
crop the one or more common anatomical locations in each of the at least one annotated baseline image and the supplement image to obtain a minimal region of interest based on the common anatomical locations.

15. The system of claim 14, wherein to register the aligned images the processor is configured to:
identify a voxel in the supplement image that corresponds one or more voxels in the at least one annotated baseline image; and
identify a barycenter of the lesion of interest in the annotated baseline image.

16. The system of claim 15, wherein the processor is configured to:
determine a voxel coordinate in the supplement image that corresponds to the barycenter of the lesion of interest in the at least one annotated baseline image.

17. The system of claim 16, wherein the processor is configured to:
estimate a deformation field between the aligned images; and
apply a deformation field to determine the voxel coordinate in the supplement image.

18. The system of claim 17, wherein the processor is configured to:
identify a barycenter of the lesion of interest in the supplement image; and
perform universal segmentation on the supplement image based on the identified barycenter of the lesion of interest to predict the new lesion contours in the supplement image.

19. A non-transitory computer readable medium storing program code for propagating a lesion to measure tumor progression and response, which when placed in communicable contact with a computing system the computer readable medium causing the computing system to perform operations comprising:
receiving, by a receiving device of a computing system, plural images of a patient obtained during plural computed tomography scans, the plural images including a set of baseline images and a set of supplement images obtained at a different time points;
analyzing, by at least one processor of the computing system, each received image to detect an organ and perform organ segmentation on the image in which an organ is detected;
receiving, by an input device of the computing system, a contour input for at least one baseline image in the set of baseline images on which organ segmentation is performed, the contour input annotating the at least one baseline image to delineate a lesion of interest on an organ;
identifying, by the at least one processor, correspondence between one or more anatomical locations in the at least one annotated baseline image and a supplement image in the set of supplement images to establish an image pair;
aligning, by the at least one processor, the annotated baseline image and the supplement image of the of the image pair;
registering, by the at least one processor executing a phase-agnostic algorithm, the aligned images of the image pair to identify coordinates of the lesion of interest;
performing, by the processor, universal lesion segmentation on the registered images of the image pair to predict new lesion contours for the lesion of interest;
extracting, by the at least one processor, biomarkers from the registered and aligned images of the image pair based on the new lesion contours associated with the lesion of interest; and
generating, by the processor, an output signal including the biomarkers.
